(19) United States
(12) Patent Application Publication
(10) Pub. No.: US 2001/0033484 A1
(43) Pub. Date: Oct. 25, 2001

(54) Night light and accessory grill

(76) Inventor: Peggy N. Gilley, Lexington, NC (US)

Correspondence Address: ROBERT W PITTS, PO BOX 11483, WINSTON-SALEM, NC, 27116-1483, US

(21) Appl. No.: 09/789,260

(22) Filed: Feb. 20, 2001

Related U.S. Application Data
(60) Provisional application No. 60/183,841, filed on Feb. 22, 2000.

(51) Int. Cl. F27D 21/02

(52) U.S. Cl. 362/92; 362/154

(57) ABSTRACT

A barbecue grill includes a light mounted on the hood of the grill to illuminate not only the grilling area, but also storage areas located below or beside the grill. One storage area can include a glass front so that food stored in this storage area can be illuminated by the light. The light can be mounted on the grill hood handle or it can be clipped directly to the hood. The light can also be part of a replaceable handle assembly for use on existing grills. The light is preferable one that will not attract insects and can be a battery powered fluorescent light or a neon light that can be also added for decoration.

### CROSS REFERENCE TO PRIOR COPENDING APPLICATION

This application claims the benefit of prior copending Provisional Patent Application No. 60/183,841, filed Feb. 22, 2000 and entitled Night Light and Accessory Grill.

### BACKGROUND OF THE INVENTION

1. Field of the Invention

The present invention relates to barbecue grill accessories and more particularly to a night light and accessory grill that may include a standard charcoal type barbecue grill or a gas grill having a number of added features for the convenience of the user such as a temperature gage, a handle mounted on a battery powered light, a flip open glass front storage space for storing the food, a side mounted shelf, a pull out drawer for utensils and seasonings, a pullout charcoal and ashtray and a bottom mounted storage rack. The light chosen for this application does not attract insects. The light may also be included as part of a replacement handle that can be mounted on an existing grill or the light itself can be mounted on the hood of a conventional grill.

2. Description of the Prior Art

Conventional charcoal or gas grills are often used at night or on low light conditions. These conventional grills do not provide adequate illumination to permit the user to check the progress of the food being grilled. It has been suggested that lights be mounted on the hood of a grill so that the light will illuminate the grilling area when the hood is opened. U.S. Pat. No. 5,457,169 discloses a lighting apparatus arranged for fixed securement to an upper barbecue grill housing adjacent to and positioned below an existing handle on the hood, so that when the hood is lifted the lighting apparatus directs illumination on the grill grate. This device appears to include multiple incandescent bulbs and an hand operated crank generator to power the lights. U.S. Pat. No. 6,132,055 discloses a handle assembly that is mounted on the lid or hood of a barbecue grill. The handle includes at least one bracket attached to the lid or hood and a tubular handle that includes a light source in the form of individual bulbs or a fluorescent light and ballast assembly. The tube has a clear plastic outer housing, and the brackets position this lighted tube below the bottom edge of the lid or hood so that the light is directly above the grill area when the pivotal hood is opened. However, this places the handle directly above the grilling area when it will be heated and where it may be contaminated by smoke carbon with continued use. Furthermore, neither of these devices provides a means for illuminating areas other than the grilling area.

### SUMMARY OF THE INVENTION

Barbequing can require the storage and retrieval of many items during the barbequing process. It would be a benefit, therefore, to have a barbecue grill, which included a number of storage facilities for storing various items of cooked, uncooked and seasoning items as well as utensils. In addition, because barbequing can occur in dark or dimly lit areas, it could be a further benefit to have a barbecue grill with a swiveling light.

It is thus an object of the invention to provide a barbecue grill having a temperature gage, a handle mounted battery powered swiveling light, a flip open front storage space for storing food, a side mounted covered storage tray for uncooked food, a side mounted shelf, a pull out drawer for storing utensils and seasonings, a pull out charcoal and ashtray, and a bottom mounted storage rack. A pair of wheels is attached to the legs of one end to allow for easy moving. The grill can be either charcoal or gas fired. When the grill is charcoal fire, a slide out ashtray can be provided for removal of the spend charcoal. These objects can be achieved by a light and barbecue grill apparatus having the following characteristics, and which brings all items that are necessary for grilling together in one organized unit.

The apparatus according to this invention comprises a grill for the outdoor preparation of food. The grill enclosed by a hood that can be opened to expose the grill. A handle on the hood is used to open the hood, and a light is mounted the hood in the vicinity of the handle to illuminate the grill when the hood is raised. This grilling apparatus also includes at least one storage area positioned below the grill, the light being positioned on the hood in a position to illuminate the storage area when the hood is raised.

In another aspect, this invention comprises a replacement handle for use on conventional barbecue grills as a replacement for an original equipment handle used to raise a hood on a conventional barbecue grill to expose a grilling area. This replacement handle includes a pair of arms that can be attached to the hood by fasteners upon removal of the original equipment handle. The arms include laterally adjustable mounting means for mounting the handle to hoods of different types having attachment points spaced apart by differing distances. A handgrip extends between the arms to be spaced from the hood when the handle is mounted on the hood. A tubular light source located adjacent to the handgrip is spaced from the hood by a distance sufficient to illuminate the grilling area when the hood is raised.

This light source for use in illuminating a grilling area of a barbecue grill when a hood on the grill is raised, the light source can also include a tubular light to which insects are not attracted, and at least one fastener that can be attached to the hood on the grill to position the tubular light a sufficient distance from the hood to illuminate the grilling area of the barbecue grill when the hood is raised. A battery holder attached to the tubular light to power the light is also included.

### BRIEF DESCRIPTION OF THE DRAWINGS

FIG. 1 is a view of a grill assembly according to one embodiment of this invention, in which the grill assembly included not only a grill with a hood that is rotated to an open position, but also includes a plurality of storage areas included drawers located below the grill, and shelves or storage trays located beside the main grilling area.

FIG. 2 is a top view of a handle assembly, including a light, that can be used as a replacement handle for existing conventional grills or that can be used on the grill of the preferred embodiment shown in FIG. 1.

FIG. 3 is a top view showing another embodiment in which a light in the form of a neon light has be clipped directly to the hood.

FIG. 4 is a view of a clip that can be used to mount a neon light to the hood in the embodiment of FIG. 3.

### DETAILED DESCRIPTION OF THE PREFERRED EMBODIMENT

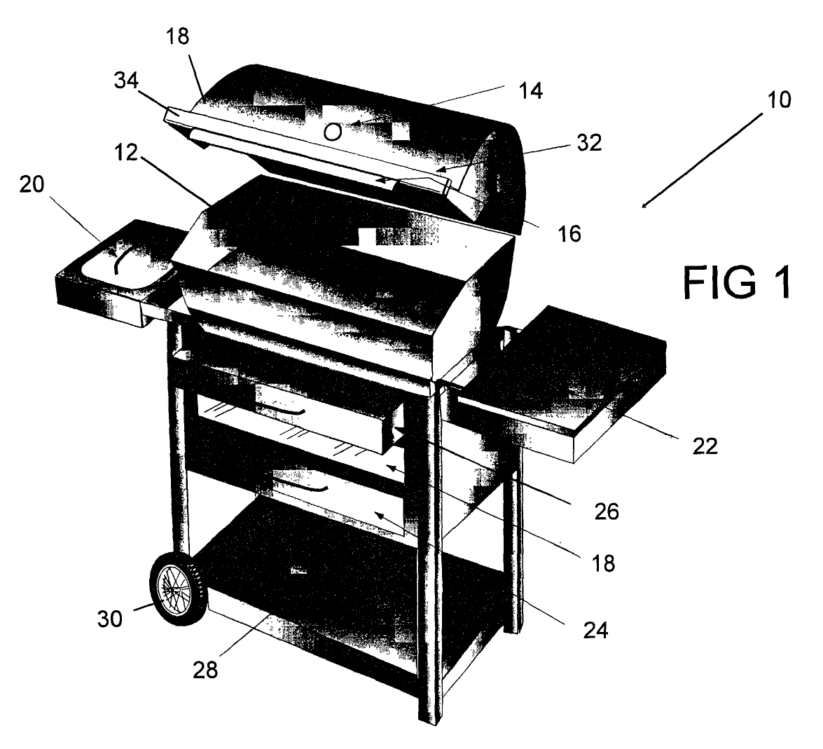

FIG. 1 shows and exemplary embodiment of the night light and accessory grill of the present invention generally designated 10. Night light and accessory grill 10 includes a grill generally designated 12 having a temperature gauge 14, a handle mounted light 16, a flip open front storage space for food 18, a side mounted covered storage trays for uncooked food 20, a side mounted shelf 22, a pull out drawer for storing utensils and seasonings 24, a pull out charcoal ashtray 26 and a bottom mounted storage rack 28, and a pair of wheels 30 for ease in movement of grill 10. An auxiliary cooking apparatus, such as a deep fryer can also be mounted on the side of the grill assembly in place of one of the side storage devices shown in the preferred embodiment. The apparatus 10 also includes a lid or hood 32 that rotates about a hinge located at the rear of the grill 12 to open the hood and expose the grilling area. The hood also closes the cooking area to smoke meat being barbecued. A handle 34 protrudes from the front of the hood 32 at its base and provides a means for lifting the hood 32.

In this preferred embodiment, the light 16 is positioned adjacent to the handle 34, and in the preferred embodiment the light 16 is located between the handgrip, which extends parallel to the front face of the hood 32, and the front of the hood. By positioning the light 16 in this position, it is capable of not only illuminating the grilling area on the top of the grill 12, but also the storage areas below the grilling area and to the sides of the grilling area. By positioning the light 16 adjacent the bottom edge of the hood 32, the light can simultaneously illuminate both the grilling area and the storage areas. The light 16 does not protrude below the hood 32, so the light 16 will not be significantly exposed to the heat from the grilling area when the hood is partially or completely opened.

The food storage area 18 also has a glass or transparent front so that the light 16 will at least partially illuminate the interior of this food storage area 18. The light will also illuminate the storage drawer 24, when it is opened and the storage area 28 at the bottom of the apparatus 10.

Since the light 16 will primarily be used at night and in darkened outdoor areas, the light should preferably be of the type that will not attract insects. It is also desirable for the light 16 uniformly illuminate the entire area between the ends of the grilling area, as well as the storage areas below the grill. For this reason, the light 16 should preferably be a tubular light, such as a fluorescent light or a neon light. Such a tubular light will radiate in all directions between its ends, so the light need not be swiveled when the hood 32 is raised. Alternatively, a reflector could be added above such a light, and the reflector and or the light could be mounted to swivel as the hood is opened so as to illuminate the grilling and storage areas as much as possible. Although a fluorescent or neon light is preferred, a plurality of individual bulbs could be employed and a light pipe or optical fiber that is illuminated by a light source located at one end could also be used. The light source will also be attached to a source of electrical power. The light could be connected directly to a source of alternating current, but that would not be the preferable manner of powering the light 16. Normally a battery would be employed to power the light. This battery would be mounted in a conventional battery holder located on the hood 32 or elsewhere on the apparatus 10. This battery could also be backed up by a solar cell that could recharge the battery during the daylight hours. A switch would also be included so that the light 16 could be activated only when needed to conserve battery power.

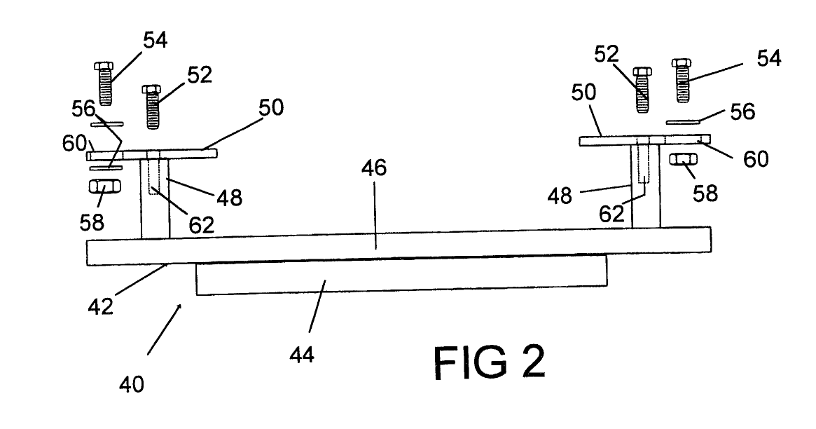

The lighting assembly can be included on a new grill, such as that shown in FIG. 1, but it can also be part of a replaceable handle assembly 40 that would be used to retrofit an existing grill. FIG. 2 shows a top exploded view of such a replaceable handle assembly 40. This assembly includes a handle 42 to which a tubular light apparatus 44 has been attached by conventional fastening means. The handle includes a handgrip 46 located on the front and two arms 48 located adjacent opposite ends of the handgrip 46. An adapter plate 50 is mounted on the end of each arm 48 is attached to the respective arm 48 by a screw 52 received with a screw hole 62, or other conventional fastening means. Although many existing gas and charcoal grills have a handle of this type, grills from different manufacturers have handles that have different lengths, so that the attachment points are spaced apart by different distances for different grills. So that the same replacement handle 40 can be used on grills from different manufacturers, the adapter plate includes an oval slot 60 which permits a screw 54, and one or more washers 58, to be aligned with a screw hole in a specific grill. Since most conventional grills employ a handle that is bolted on, bolts 58 will be used to attached the screws to the hood or lid of the conventional grill.

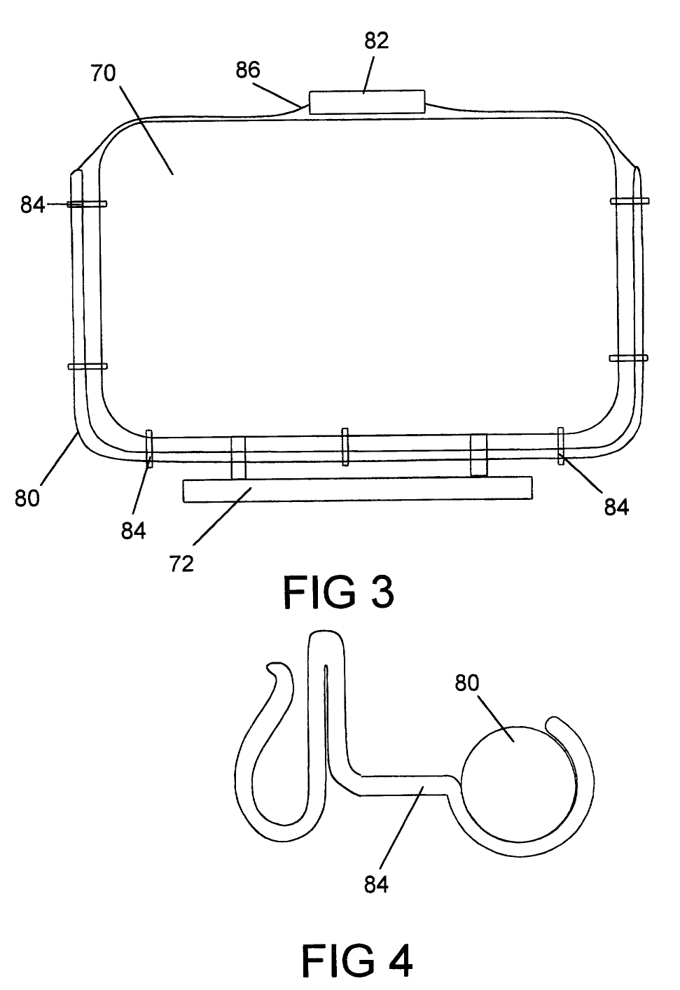

FIGS. 3 and 4 show another embodiment in which the light source 80 is mounted along the bottom edge of a barbecue grill hood 70, but need not be mounted directly to the handle 72. This embodiment depicts a neon light 80, which will not attract insects, and will provide decoration as well as illumination. The neon light 80 is mounted on the hood 70 by metal clips 84 which can be snapped to the grill hood 70, and which includes a generally circular support section in which the neon light 80 can be positioned as shown in FIG. 4. Of course other mounting means can be used. A power supply or battery 82 can also be mounted on the grill hood 70, and the neon light 80 can be attached by wires 86 to the power supply. It would also be possible to provide a light and a power source as an integral unit that could be mounted on the grill.

It is noted that the embodiment of the night light and accessory grill described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

I claim:

1. An apparatus for the outdoor preparation of food comprising:
a grill enclosed by a hood that can be opened to expose the grill;
a handle on the hood for opening the hood;
a light mounted the hood in the vicinity of the handle positioned to illuminate the grill when the hood is raised; and
at least one storage area positioned below the grill, the light being positioned on the hood in a position to illuminate the storage area when the hood is raised.

2. The apparatus of claim 1 wherein the hood is pivoted relative to the grill.

3. The apparatus of claim 2 wherein a first storage area includes a transparent front so that food positioned in the first storage is visible when illuminated by the light.

4. The apparatus of claim 2 wherein a second storage area comprises a pull out drawer.

5. The apparatus of claim 1 wherein the light comprises a light that does not attract insects.

6. The apparatus of claim 1 wherein the light comprises a neon light.

7. The apparatus of claim 1 wherein the light comprises a fluorescent light.

8. The apparatus of claim 1 wherein a plurality of storage areas are located below the grill.

9. The apparatus of claim wherein a food storage area having a transparent front is located above a pull out drawer.

10. The apparatus of claim 9 wherein a removable ash and charcoal collection tray is located above the food storage area and a storage rack is located below the pull out drawer.

11. The apparatus of claim 10 wherein wheels are mounted on the apparatus so that the apparatus is portable.

12. The apparatus of claim 01 wherein the light powered by a battery.

13. The apparatus of claim 12 wherein the battery is rechargeable by a solar cell.

14. A replacement handle for use on conventional barbecue grills as a replacement for an original equipment handle intended to raise a hood on a conventional barbecue grill to expose a grilling area; the replacement handle comprising:
a pair of arms attachable to the hood by fasteners upon removal of the original equipment handle, the arms including laterally adjustable mounting means for mounting the handle to hoods of different types having attachment points spaced apart by differing distances;
a handgrip extending between the arms to be spaced from the hood when the handle is mounted on the hood; and
a tubular light source located adjacent to the handgrip and also spaced from the hood by a distance sufficient to illuminate the grilling area when the hood is raised.

15. The replacement handle of claim 14 wherein the replacement handle includes a battery for energizing the light source.

16. The replacement handle of claim 14 wherein the tubular light source comprises a light source that does not attract insects so that the light source can be used at night.

17. The replacement handle of claim 14 wherein the tubular light source comprises a neon light

18. A light source for use in illuminating a grilling area of a barbecue grill when a hood on the grill is raised, the light source comprising:
a tubular light to which insects are not attracted:
at least one fastener attachable to the hood on the grill to position the tubular light a sufficient distance from the hood to illuminate the grilling area of the barbecue grill when the hood is raised; and
a battery holder attached to the tubular light to power the light.

19. The light source of claim 18 wherein the fastener comprises means for attaching the tubular light to a handle on the hood of the grill.

20. The light source of claim 18 wherein the tubular light comprises a neon light.
